(19) United States
(12) Patent Application Publication
(10) Pub. No.: US 2007/0016561 A1
(43) Pub. Date: Jan. 18, 2007

(54) Electronic report generator

(75) Inventor: Torben Laustsen, Vaerloese (DK)

Correspondence Address: LEE & MORSE, P.C., 3141 FAIRVIEW PARK DRIVE, SUITE 500, FALLS CHURCH, VA, 22042, US

(73) Assignee: Research Innovation Aps

(21) Appl. No.: 11/220,416

(22) Filed: Sep. 7, 2005

(30) Foreign Application Priority Data
Jul. 3, 2005 (DK) PA 2005 00984

(51) Int. Cl. G06F 17/30

(52) U.S. Cl. 707/3

(57) ABSTRACT

An electronic report generator includes a processor connected to a memory having data organized in records and variables, and a user interface with a display for displaying symbols in a work area of the display. Each symbol represents a variable of the data. The processor is adapted to receive a command from the user interface for selection of a variable from the displayed variables, selection of a template for definition of the presentation of the selected variables, creation of a report structure in a report area of the display, and selection of the output file type of the report.

### FIELD OF THE INVENTION

The present invention relates to an electronic report generator for automatic generation of reports in Microsoft® Word, Microsoft® Excel or Microsoft® PowerPoint® containing data selected from a large dataset.

### BACKGROUND OF THE INVENTION

Typically, market researchers, controllers and anybody that works with presentation of data expend a considerable amount of time and effort to prepare reports and presentations. Conventionally, data are extracted from tables followed by examination and analysis, and results are finally summarized in a Microsoft® Word document and/or a Microsoft® PowerPoint® presentation. The report documents typically contain many graphs and tables.

Further, there is often a need for various versions of a report, each version being suitable for a specific market, a specific department, specific individuals, or specific time periods. Manual generation of different versions is also tedious, time consuming and includes the risk of man-made errors.

Software tools for preparation of reports already exist, such as E-Tabs, which automates the production of tables, graphs and reports for presentation purposes in the Office System based on tables imported from standard software for tabulation, such as SPSS. Likewise, software, such as SPSS, is capable of transforming a dataset in a record format into a group of SPSS based tables and graphs, which subsequently can be organized in a Microsoft® Excel, Microsoft® Word or Microsoft® PowerPoint® document utilizing object linking and embedding (OLE) technology.

### SUMMARY OF THE INVENTION

The present invention is therefore directed to an electronic report generator, which substantially overcomes one or more of the problems due to the limitations and disadvantages of the related art.

It is a feature of an embodiment of the present invention to provide an electronic report generator that displays an overview of the available data to the user.

It is another feature of an embodiment of the present invention to provide an electronic report generator that allows the user to select data from the available data to be incorporated into a report.

It is yet another feature of an embodiment of the present invention to provide an electronic report generator that allows the user to format the data into text, tables or graphs, add further text.

It is still another feature of an embodiment of the present invention to provide an electronic report generator that allows the user to select the output file type of the generated report.

According to the present invention, the above-mentioned and other features and advantages may be realized by providing an electronic report generator including a processor that is connected with a memory having data organized in records and variables, and a user interface with a display for displaying symbols in a work area of the display, each symbol representing a variable of the data, and wherein the processor is adapted to receive a command from the user interface for selection of a variable from the displayed variables, selection of a template for definition of the presentation of the selected variables, creation of a report structure in a report area of the display, and selection of the output file type of the report.

The template may be a Microsoft® Word template, and Microsoft® Excel template, or a Microsoft® PowerPoint® template. The processor may further be adapted to generate a chart utilizing a Microsoft® Excel chart generator.

Thus, the electronic report generator may generate a report definition specifying the structure of the report content and the format of the content.

The report definition may be named and stored in a library of report definitions.

The report definition may be output in any file type selected from the group consisting of a Microsoft® Word file, and Microsoft® Excel file, and a Microsoft® PowerPoint® file.

The electronic report generator may have a user interface providing input tools, such as a keyboard and a pointing device, e.g. a mouse, a trackball, a pen, etc, and a cursor displayed on the display with a position on the display screen that is controlled by the pointing device, as is well known in the art. The user interface may support a character-based and/or, preferably, a graphical user interface (GUI).

The user interface may utilize conventional windows, drop down menus, toolbars, buttons, tabbed panes, labels, scroll bars etc.

In operation, the electronic report generator may display a number of records, e.g., as a matrix of rows (records) and columns (data variables) in a way similar to the manner in which a spreadsheet is displayed, thereby providing an overview to the user of the data. The generator may, for example, display a dataset provided in a conventional record format, such as Microsoft® Excel format, SPSS format, CSV format, etc., thereby providing an overview of all variables of the dataset.

The types of variables include numerical values representing continuous functions, numerical values representing discrete functions, date, time, text strings, etc.

The user interface may allow the user to select variables to be incorporated into the report to be generated. Further, the user interface allows the user to draw and update charts.

The user interface may also allow the user to define a chapter and section structure, and table, graph and text sections, and to position selected data in selected parts of the report.

The electronic report generator may make every functions of a text editor, such as Microsoft® Word, available to the user designing a report. Parts of the report designed with a text editor are included in the output report when a Microsoft(E Word file is selected as the output file. If a Microsoft® Excel file or a Microsoft® PowerPoint® file is selected as the output file, text editor designed parts may be inserted utilizing OLE technology.

Likewise, the electronic report generator may perform every function of a spreadsheet program, such as Microsoft® Excel, available to the user designing a report. Parts of the report designed with the spreadsheet program may be included in the output report when a Microsoft® Excel file is selected as the output file. If a Microsoft® Word file or a Microsoft® PowerPoint® file is selected as the output file, spreadsheet program designed parts may be inserted utilizing OLE technology.

Also, the electronic report generator may make every functions of an overhead presentation program, such as Microsoft® PowerPoint®, available to the user designing a report. Parts of the report designed with an overhead presentation program may be included in the output report when a Microsoft® PowerPoint® file is selected as the output file. If a Microsoft® Excel file or a Microsoft® Word file is selected as the output file, presentation program designed parts may be inserted utlizing OLE technology.

The resultant report may be displayed on the display in a selected output format, i.e. Microsoft® Word, Microsoft® Excel, or Microsoft® PowerPoint® format, and the user may proceed with further selection of data and report formatting, or, the user may select to name and store the report in a report library for later use, or, the user may select an output file type for generation of the report.

Upon selection of the output file type, the electronic report generator produces the report in the selected output file format, i.e. either an Microsoft® Excel document containing the defined tables and graphs, and data and text formatted in accordance with the previous user selections, or, a Microsoft® Word document with Microsoft® Excel based tables and graphs inserted utilizing OLE-technology, and text paragraphs, formatted e.g. with front pages, indexes, footers etc. in accordance with previous user selections, or, a Microsoft® PowerPoint® document with Microsoft) Excel based tables or graphs inserted utilizing OLE-technology. Preferably, the report generator utilizes Microsoft® Word and Microsoft® PowerPoint® templates for the layout of the generated report, and Microsoft® Excel based templates for the layout of tables and graphs.

The designed report may be output in the selected output file type in several versions, e.g. in different versions for different recipients of the report. The electronic report generator may provide a filter function, e.g. a filter of discrete variables (e.g. Department a, Department b, . . . Department n) on an optional variable (e.g., Department).

In addition, the electronic report generator may provide weight values e.g., to compensate for possible lack of representative data on an optional number of dimensions, such as sex, age and geography, so that each record in the dataset is assigned an individual weight, providing a weighted output in tables and graphs.

The weighting is an iterative process and it is possible to select neutral weighting or weighting of e.g., population numbers.

The electronic report generator may calculate measurable differences in the dataset (significance) automatically for display in tables by marking numbers in tables, depending on whether the value of a cell is measurably higher/lower than that to which it is compared.

A set of discrete variables may be organized in a hierarchical structure (e.g., Group 1 containing Department 1a, Department 1b . . .

Department 1n, and Group 2 containing Department 2a, etc) in the report.

For defined tables and graphs, which do not contain any data, it is possible either to produce these without data, or eliminate them.

It is possible to filter both entire presentations/reports and single graphs/tables according to a filter, so that only records meeting the condition of the filter will be included.

It is possible to make several report definitions for a specific dataset.

Fixed benchmark variables can be made for each variable, which can be activated, so that this extra dimension, showing a fixed target number, is automatically added to tables and graphs.

Dynamic benchmark variables can be made for each variable, which can be activated, so that this extra dimension, in the shape of a dynamic target number, is automatically added to tables and graphs. This number is automatically calculated on the basis of the answer pattern of the variable concerned, present in a defined subset of the total number of records in the dataset.

The electronic report generator may provide report generation in several languages so that reports and presentations may easily be provided in several languages.

Table, graph and text sections may automatically be omitted from defined reports and presentations, and results and texts may dynamically be added into text paragraphs, tables and graphs in accordance with conditions defined by the user, such as statistically measurable differences, minimum number of respondents, etc.

Thus, it is an important advantage of the present invention that a user may transform a dataset into Microsoft® Excel tables and graphs, and generate a report independent of the output file type. Further, a report may be generated in any of several file types, i.e., in a Microsoft® Excel file, a Microsoft® Word file, or a Microsoft® PowerPoint® file.

### BRIEF DESCRIPTION OF THE DRAWING

The above and other features and advantages of the present invention will become more apparent to those of ordinary skill in the art by describing in detail exemplary embodiments thereof with reference to the attached drawings in which:

FIGS. 1-19 illustrate windows displayed according to embodiments of the present invention;

FIG. 20 illustrates a block diagram of an embodiment of the present invention; and

FIG. 21 illustrates a perspective schematic view of the electronic report generator of FIG. 20.

### DETAILED DESCRIPTION OF THE PRESENT INVENTION

Danish Patent Application No. PA 2005-00984, filed on Jul. 3, 2005, in the Danish Patent Office, and entitled: “An electronic report generator,” is incorporated by reference herein in its entirety.

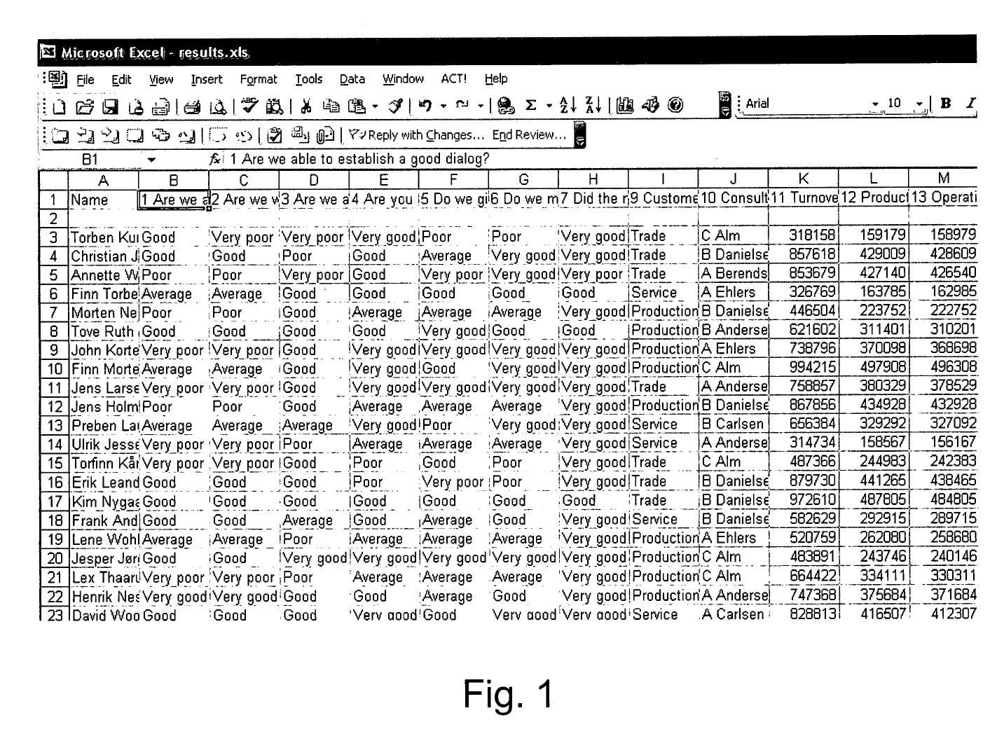

FIG. 1 illustrates a window displaying an exemplary dataset having records of variables. The dataset is provided in a Microsoft® Excel format with the records forming rows of the spreadsheet and the variables forming columns of the spreadsheet. The dataset contains the answers of individual customers to a questionnaire. Each record contains the response of an individual. The variable displayed in column A is a text string containing the name of the individual. The variables displayed in columns B through H may be discrete variables having a low number of possible values, e.g., 5 values, such as very high, high, medium, low, and very low. The variable may contain that individual's response to a statement in the questionnaire. The variable displayed in column I may be a text string containing possible comments made by the individuals. The variable in column J may be a discrete text string variable indicating the occupation of the individual. The variable in column K may also be a discrete text string variable containing the name of a sales person. The variables displayed in column L and M may be continuous numerical values, e.g., sales figures relating to the individuals.

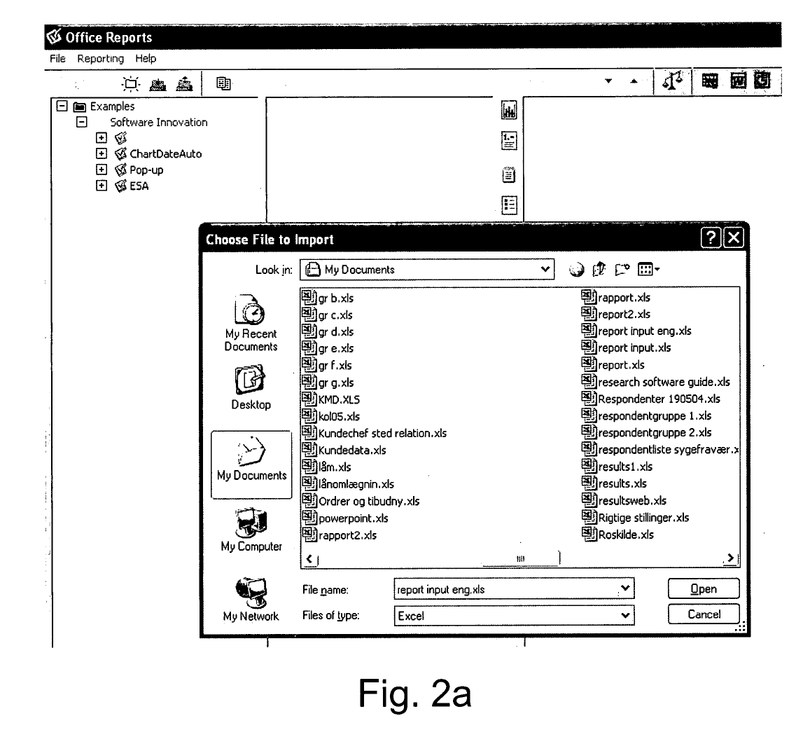

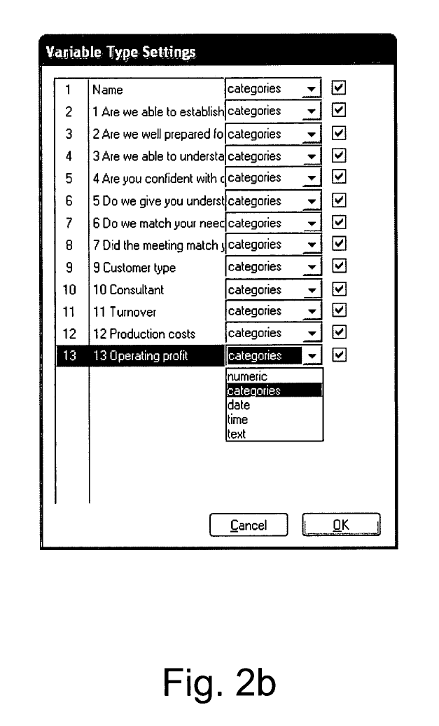

FIG. 2a illustrates a window displayed when a dataset is selected for input to the electronic report generator.

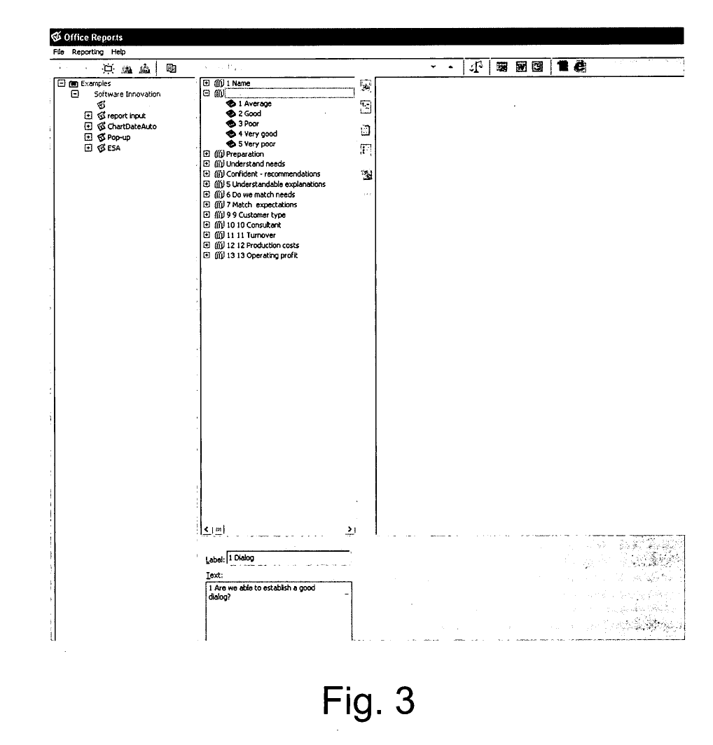

Upon import of a data file, an overview of the variables of the dataset may be created as shown in FIG. 3 in the field below the header “Variables”. The headers of the variables may be listed row by row along with a symbol indicating the type of the variable, e.g., continuous numerical variables; discrete numerical variables, text string variables, date variables, time variables, etc. Further, possible values of the variables may be displayed by clicking on the “+” symbol to the left of the variable header as shown below the first variable. For example, the possible values of a discrete numerical variable may be displayed, the smallest, the largest and the average value may be displayed for a continuous numerical variable, and the longest string may be displayed for a text string variable.

Further, when a specific variable is marked, the number of responses may be displayed. For discrete variables the number of responses per possible value may be displayed. As shown in FIG. 2b, possible variable type settings may be displayed by clicking on the down arrow, as shown below the last variable.

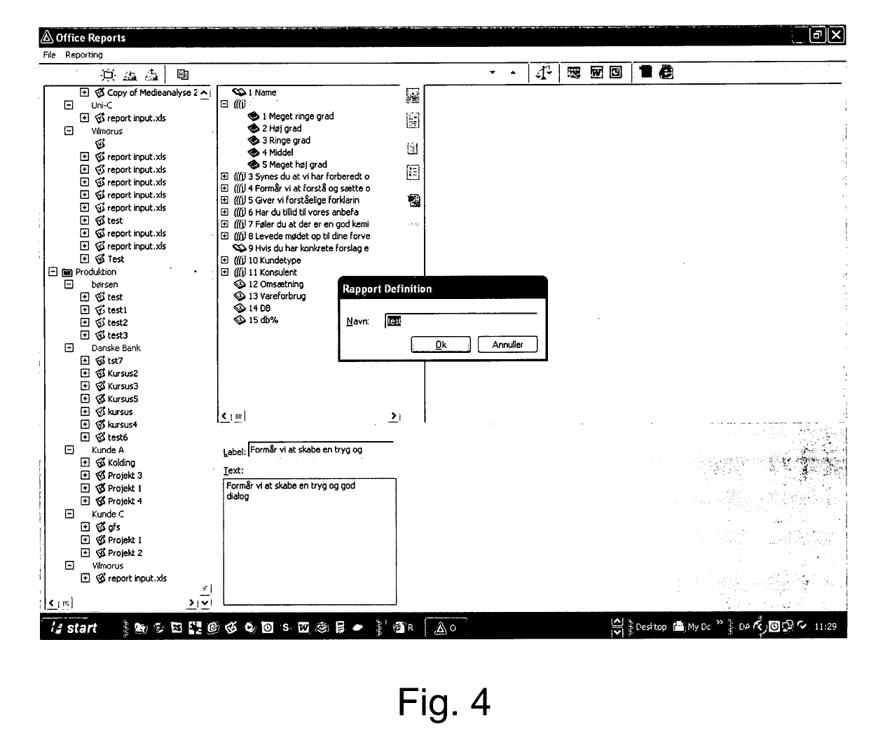

As shown in FIG. 4, the report definition may be named and stored.

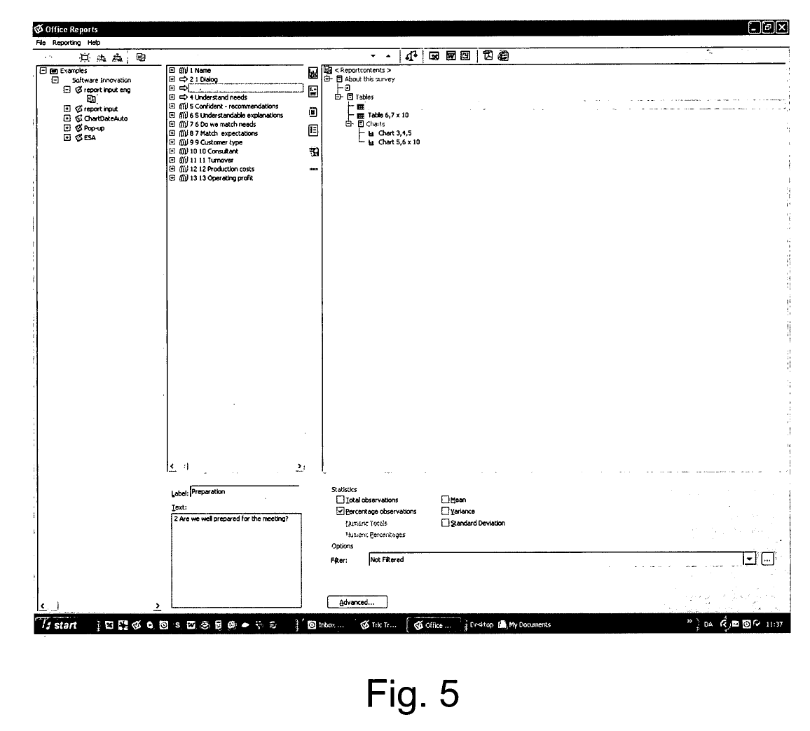

FIG. 5 illustrates a design of a report structure in the report area to the right of the display overview of the variables. In FIG. 5, the report area contains the definition of a chapter starting with a text section followed by a section with a table of variable 2, 3 and 4 and a table of variables 5, 6, and 10 followed by a section with a chart of variable 3, 4, and 5, and a chart of variable 5, 6, and 10.

The text sections, tables and charts may be created by clicking on the appropriate tool displayed between the variable area and the report area. Charts and tables may be generated using Microsoft® Excel chart generator and editor tools. Text may be generated with Microsoft® Word or Microsoft) PowerPoint® tools.

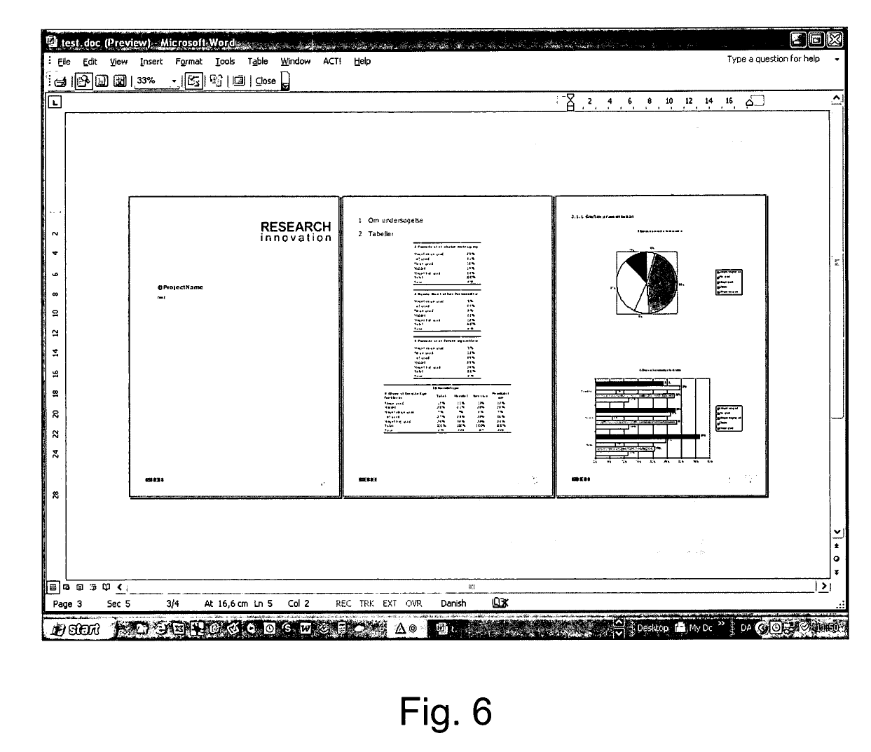

Upon report design, the user may select to output the report in a Microsoft® Word file, and Microsoft® Excel file, or a Microsoft® PowerPoint® file. In the particular example shown in FIG. 6, the report design of FIG. 5 is output in a Microsoft® Word file.

As shown in FIG. 13, it is possible to filter both entire presentations/reports and single graphs/tables according to a filter, so that only records meeting the condition of the filter will be included.

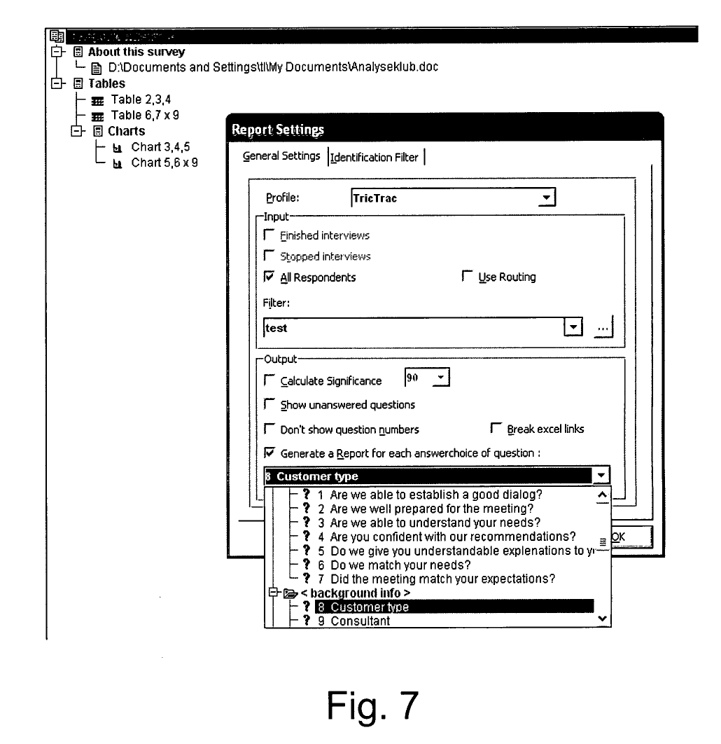

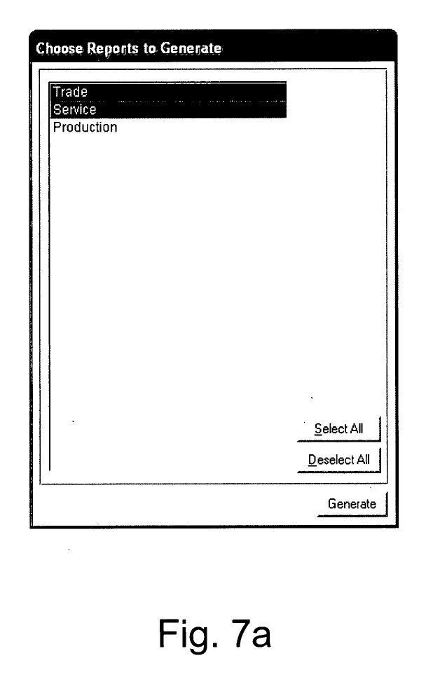

As shown in FIGS. 7 and 7a, it is possible to generate several unique reports in one process where each report is based on the same structure, but each report includes only records matching a specific variable category.

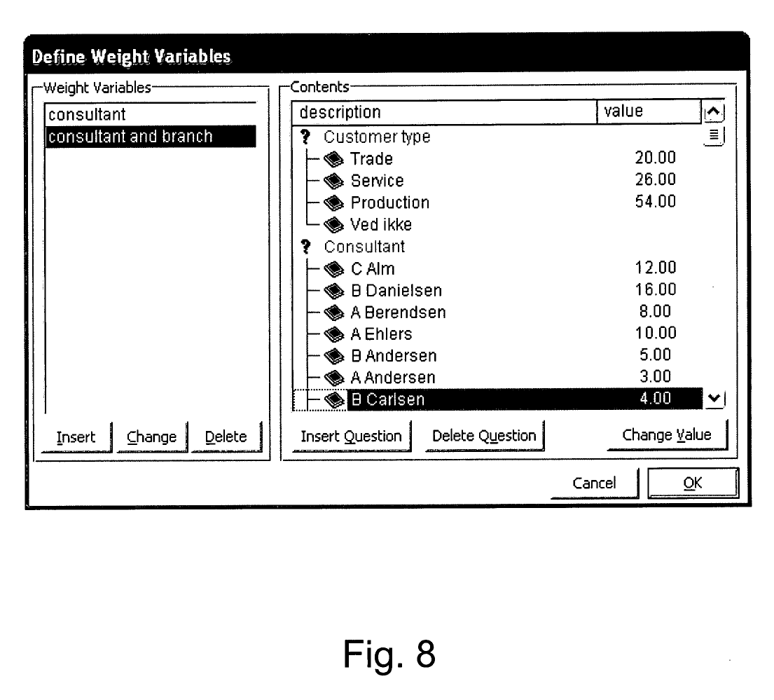

FIG. 8 illustrates incorporation of weight values. In the illustrated window, a weight variable name is displayed in the left area of the window and its weight values for the various values of the variables are displayed in the right area of the window.

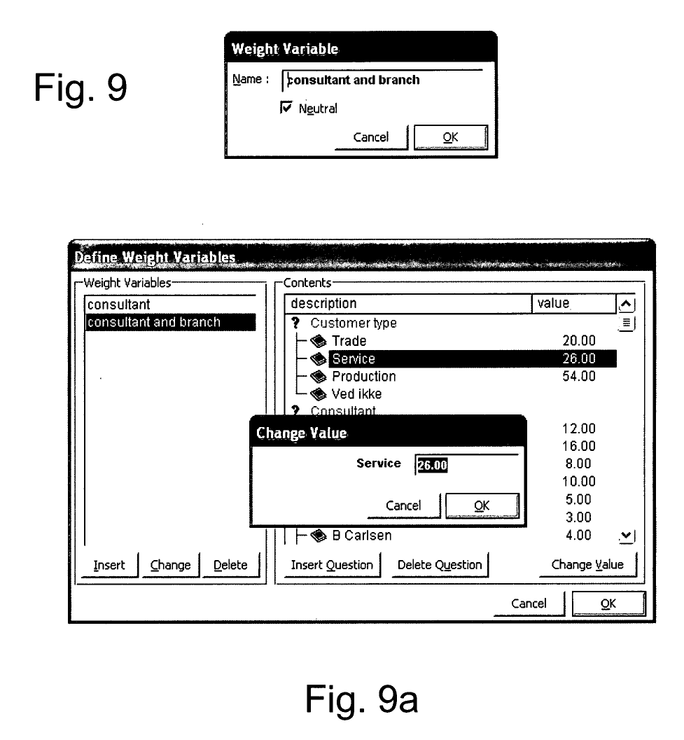

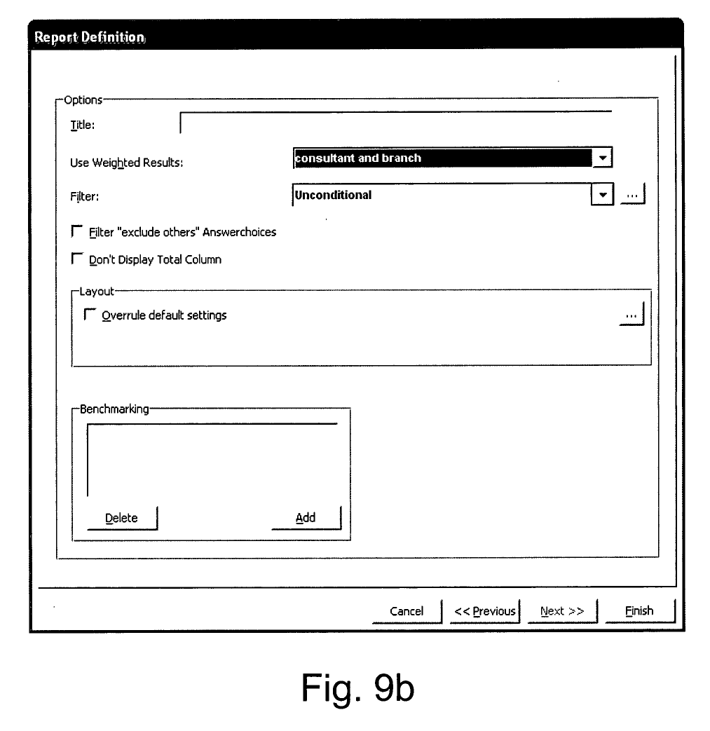

FIGS. 9 and 9a illustrate how it is possible to select neutral weighing or weighing up to, e.g., population numbers. FIG. 9b illustrates how a specific weighing can be applied to a report of a specific table- and chart definition.

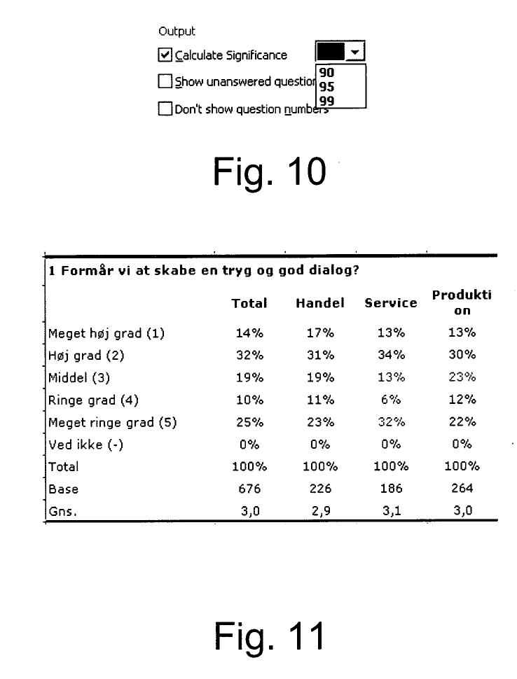

FIG. 10 illustrates how to select a calculation of significance to be activated on specific tables.

FIG. 11 illustrates calculation of percentage responses of each possible value of selected discrete variables for various categories of respondents. Also, the total number of responses may be displayed per category in the next lowest row, and the average response value for each category may be displayed in the lowest row. In the tables where significance is calculated, results in cells that are ‘significantly higher than . . . ’, may be displayed in green, and results in cells that are ‘significantly lower than . . . ,’ may be displayed in red.

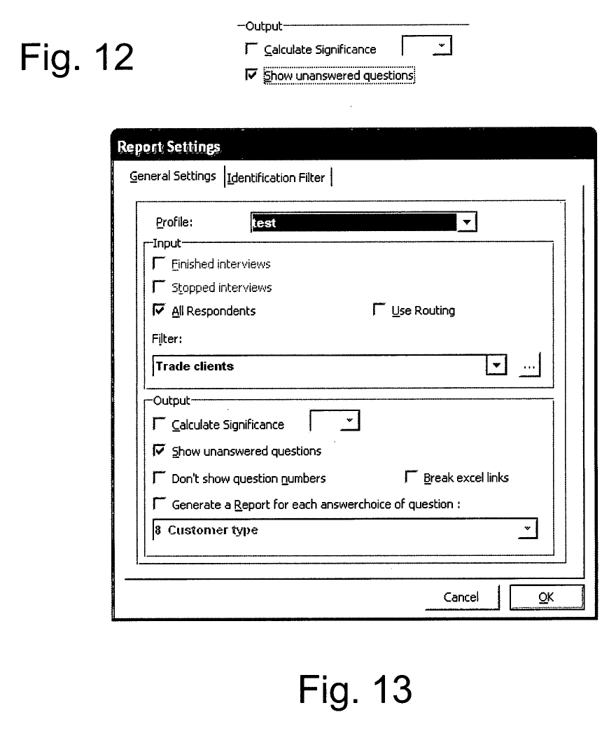

FIG. 12 illustrates that it is optional to include/exclude all tables and charts in a report which do not contain data.

FIG. 13 illustrates that tables and charts can be filtered so that they only contain records that match the filter definition.

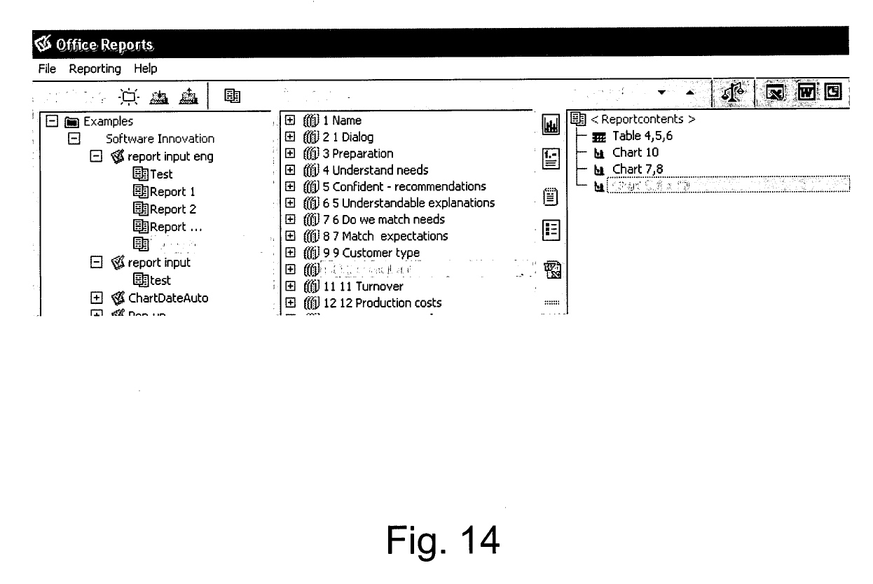

FIG. 14 illustrates how different reports, i.e., ‘Report 1’, ‘Report 2’ etc., can be defined referring to the same set of data. Each report may include an individual structure including index, chapters, tables, charts etc.

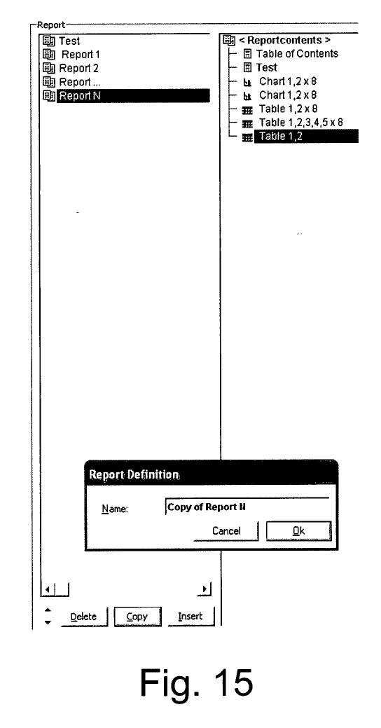

In FIG. 15, different report definitions may be displayed in the left area of the window for selection by the user. In the right area, the selected report definition may be displayed.

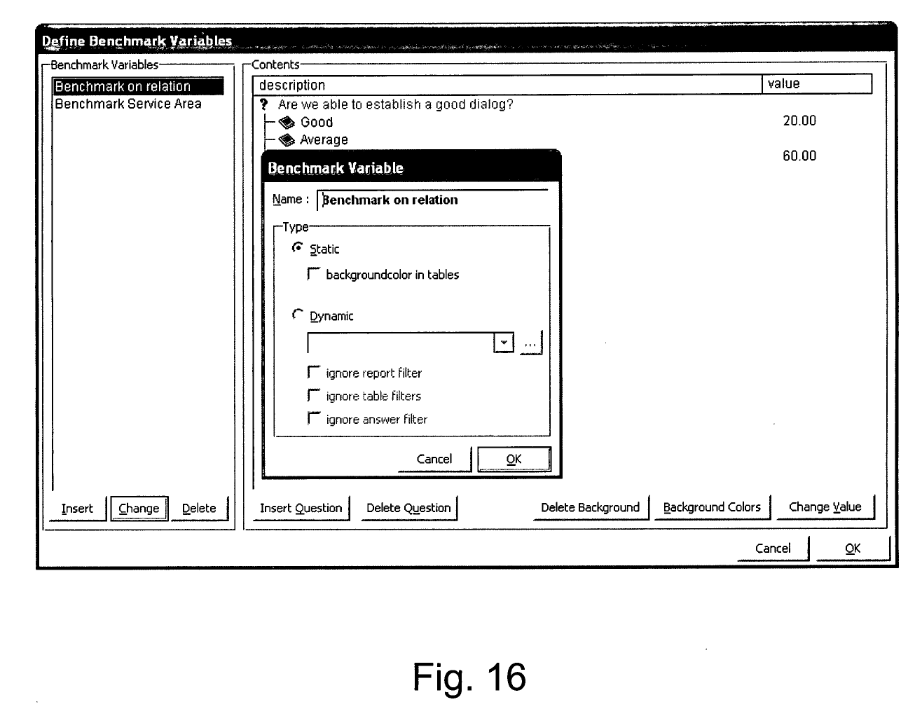

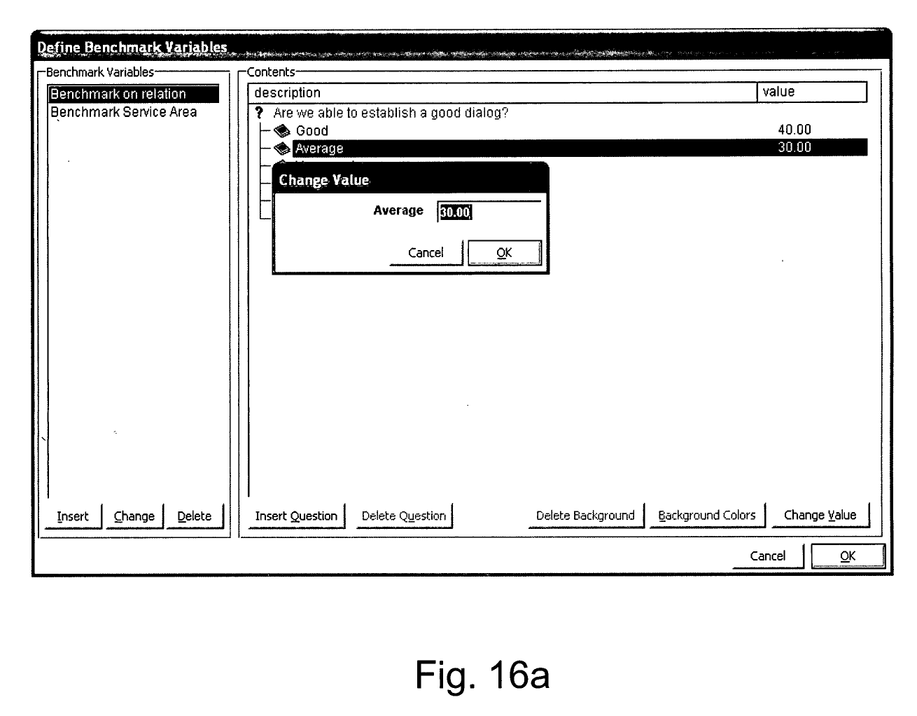

FIGS. 16 and 16a illustrate how static benchmarks can be defined.

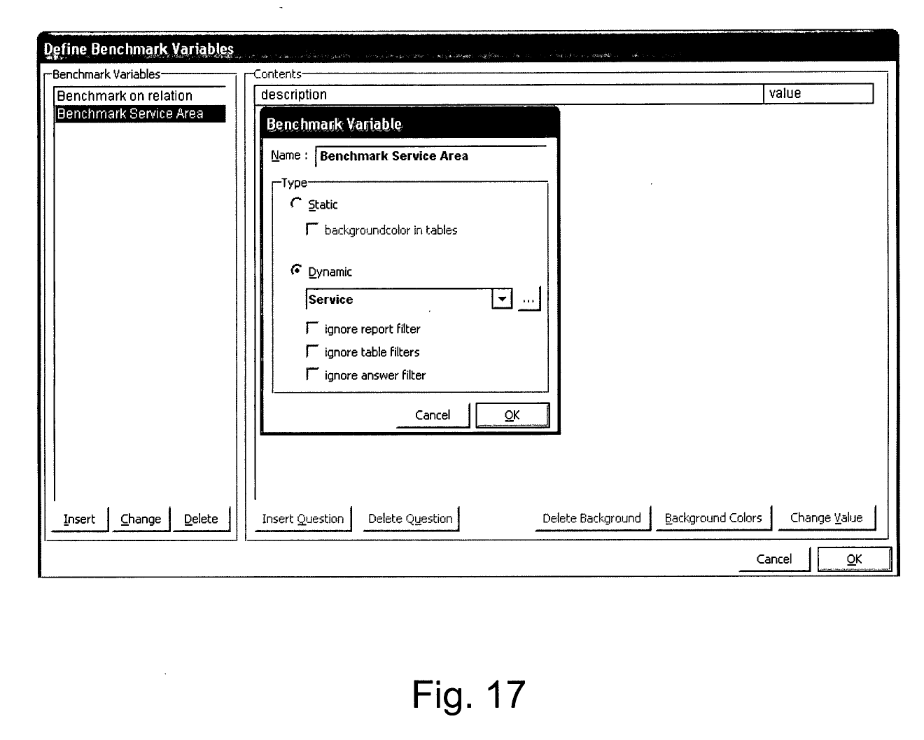

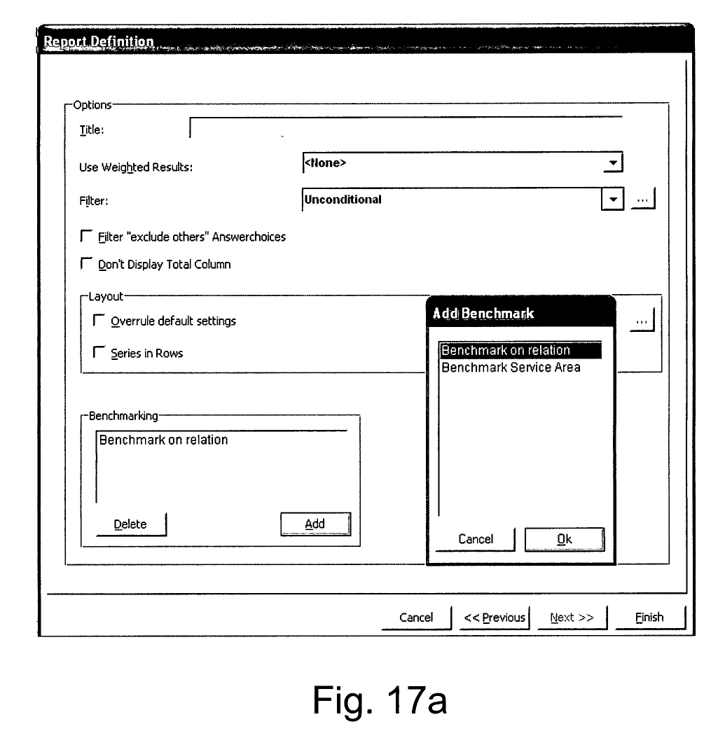

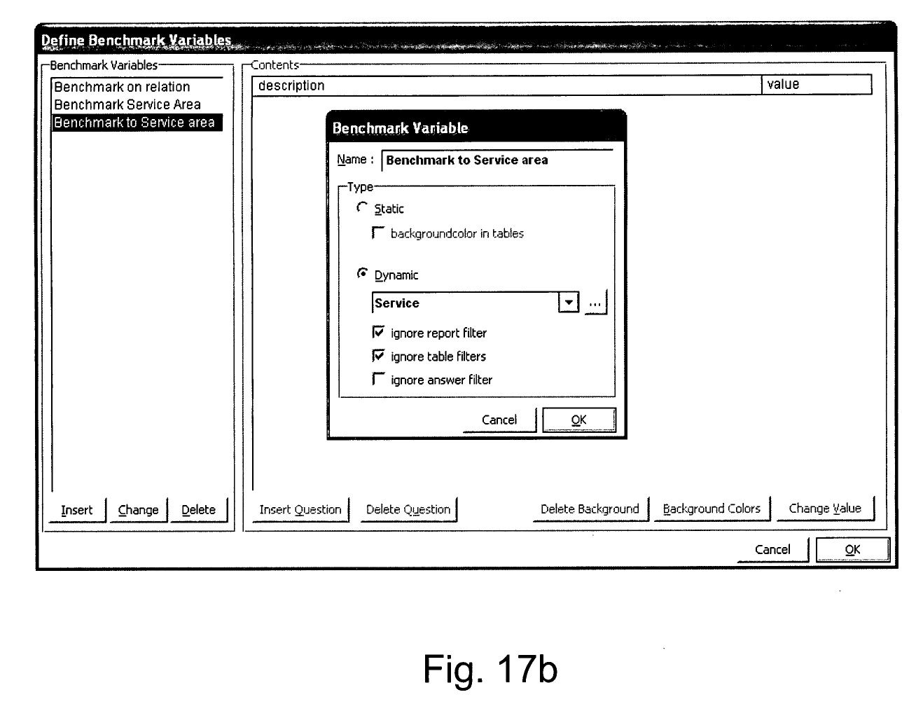

FIG. 17 illustrates how dynamic benchmarks can be defined. FIGS. 17a and 17b illustrate how benchmarks can be added as extra information in tables and charts.

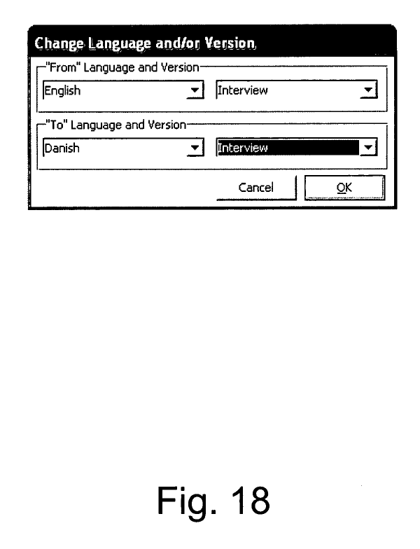

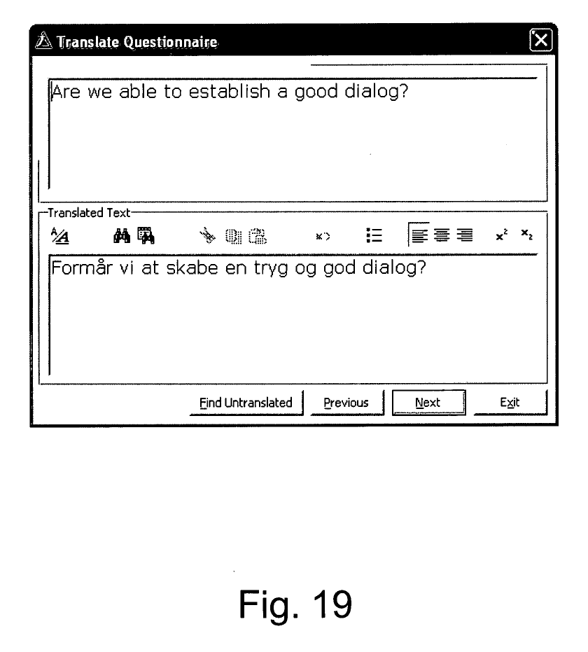

FIGS. 18 and 19 illustrate selection of different languages of the report.

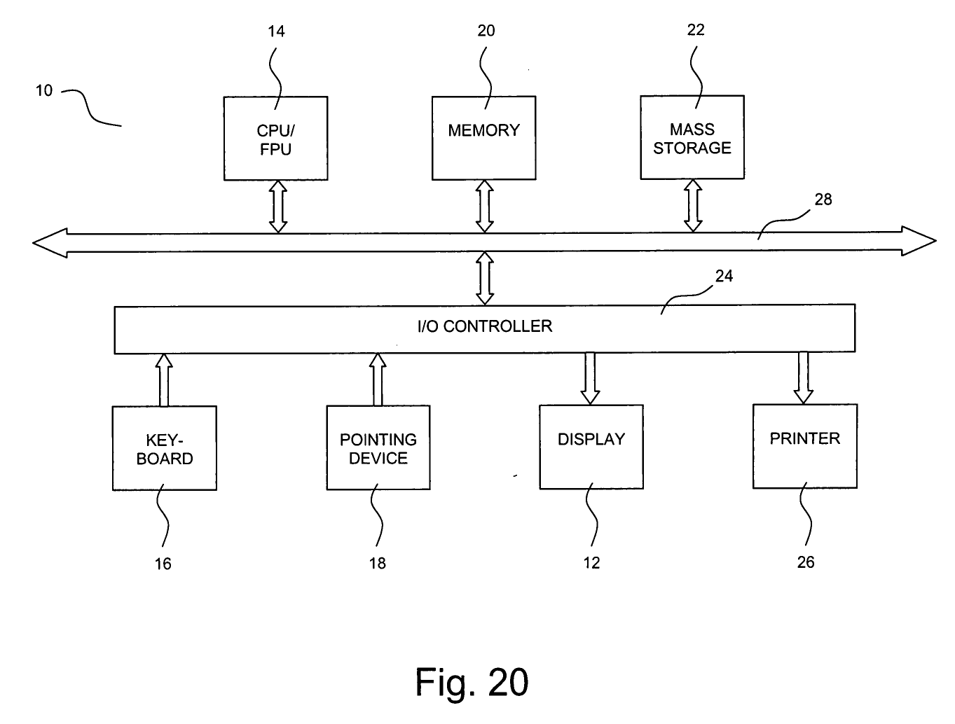

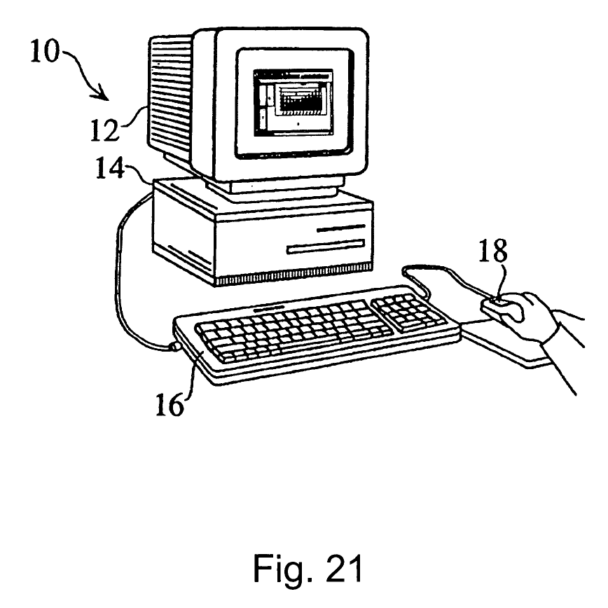

FIG. 20 illustrates a block diagram of an embodiment shown in FIG. 21. An illustrated electronic report generator 10 may include a central processing unit (CPU) 14 with a math coprocessor or floating-point processing unit (FPU), a main memory 20, an input/output controller 24, a keyboard 16 or other input device, a pointing device 18, e.g., mouse, track ball, pen device, or the like, a display 12, and a mass storage 22 (e.g., hard disk). Additional input/output devices, such as a printer 26, may be included in the system 10 as desired. As illustrated, the various components of the system 10 communicate through a system bus 28 or similar architecture.

A computer software system is provided for directing the operation of the computer system 10. The software system is stored in system memory 20 and on disk memory 22, includes a kernel or operating system and an interface. One or more application programs may be “loaded” (i.e., transferred from storage 22 into memory 20) for execution by the system 10. The system 10 receives user commands and data through the user interface, e.g., the keyboard 16 and the pointing device 18. These inputs may then be acted upon by the system 10 in accordance with instructions from the operating system module and/or the application module. The interface, which may support a character-based and/or preferably a graphical user interface (GUI), also serves to display results, whereupon the user may supply additional inputs or terminate the session.

FIG. 21 illustrates a perspective schematic view of an electronic report generator 10 according to an embodiment of the present invention. The illustrated electronic report generator 10 includes a personal computer with the processor 14, the memory 20, an internal hard disc for the mass storage 22, a CD-ROM drive, an audio capability, the display 12, the keyboard 16, and the pointing device 18, e.g., a track ball or a mouse. In FIG. 21, the image of FIG. 6 is displayed on the display screen. The display 12 may have a touch sensitive display screen. It will be appreciated by those skilled in the art that the actual hardware implementation of the system is a matter of design choice. Thus, the electronic report generator may be distributed across a network connected to a server, e.g., it may be provided by an on-line service for example via the Internet. For example, the computer 10 may be a portable computer that can be connected to the Internet via a mobile phone or via a wireless network, e.g., a hot spot, or the user may be connected to the Internet via a broadband connection, e.g. utilizing the user's TV.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

1. An electronic report generator, comprising:
a processor connected to a memory having data organized in records and variables, and
a user interface with a display for displaying symbols in a work area of the display, each symbol representing a variable of the data, and wherein the processor is adapted to receive a command from the user interface for
selection of a variable from the displayed variables,
selection of a template for definition of the presentation of the selected variables, and
creation of a report structure in a report area of the display, and selection of an output file type of the report.

2. The electronic report generator according to claim 1, wherein the output file type is selected from the group consisting essentially of a Microsoft® Word file, and Microsoft® Excel file, and a Microsoft® PowerPoint® file.

3. The electronic report generator according to claim 2, wherein the processor is further adapted to generate a chart utilizing a Microsoft® Excel chart generator.

4. The electronic report generator according to claim 1, wherein a report definition containing the report content and formatting may be named and stored in a library of report definitions.

5. The electronic report generator according to claim 1, wherein a list of headers of the variables of the input dataset is displayed row by row along with a symbol indicating the type of each variable.

6. The electronic report generator according to claim 5, wherein possible values of the variables are displayed adjacent the respective variable header.

7. The electronic report generator according to claim 5, wherein the number of responses for a variable is displayed adjacent the respective variable header.

8. The electronic report generator according to claim 1, wherein the processor is further adapted to form calculations on the input data thereby generating new data for incorporation into the report in the same way as the original input data.

9. The electronic report generator according to claim 8, wherein the processor is further adapted to include user selected weight functions in the calculation.

10. The electronic report generator according to claim 1, wherein the processor is further adapted to generate several output report versions based on a report definition as defined by a filter function.

11. The electronic report generator according to claim 1, wherein the processor is further adapted to provide output reports in different selected languages.

12. The electronic report generator according to claim 1, wherein the processor is further adapted to include selected table, graph and text sections in an output report file provided that user defined conditions are fulfilled.

13. A method of generating an electronic report, comprising:
accessing data in records and variables;
displaying symbols in a work area of a display, each symbol representing a variable of the data; and
providing a user interface for
selecting a variable from the displayed variables,
selecting a template for definition of the presentation of the selected variables,
creating a report structure in a report area of the display, and
selecting an output file type of the report
